(19) United States
(12) Patent Application Publication
(10) Pub. No.: US 2008/0187239 A1
(43) Pub. Date: Aug. 7, 2008

(54) SYSTEM AND METHOD FOR CORRECTING AN IMAGE

(75) Inventors: CHIH-KUANG CHANG, Tu-Cheng (TW); LI JIANG, Shenzhen (CN); XIAO-CHAO SUN, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/944,424

(22) Filed: Nov. 22, 2007

(30) Foreign Application Priority Data
Feb. 6, 2007 (CN) 200710200156.4

(51) Int. Cl. G06K 9/40

(52) U.S. Cl. 382/275

(57) ABSTRACT

A method for correcting an image is provided. The method includes: mapping a regular grid according to the length and the width of a work plane of a measuring machine, and a preconfigured interval of the grid, wherein intersecting points of the regular grid refer to reference points; computing deviation values of all the reference points; capturing a digital image of a physical object through the measuring machine; correcting the real coordinate value of all points of the digital image according to the deviation values of the reference points. A related system is also provided.

### BACKGROUND OF THE INVENTION

1. Field of the Invention

The present invention generally relates to a system and a method for correcting an image.

2. Description of Related Art

In the precision measurement field, a CCD (charge coupled device) installed in a measuring machine can capture an image of a physical object through focusing the physical object by a lens. However, due to some factors, for example, characteristics of the CCD and the Lens, the image may be inaccurate. If the image is magnified, the image may be deformed.

FIG. 1 is a schematic diagram of an original regular grid, and FIG. 2 is a schematic diagram of an image of the regular grid in FIG. 1. The image is captured by the CCD. It can clearly be seen that the grid in FIG. 2 is deformed.

In order to eliminate or weaken the deformation of the image, a system and a method for correcting the image need to be provided.

### SUMMARY OF THE INVENTION

A system for correcting an image is provided. The system includes a computer and a measuring machine. The measuring machine includes a charge coupled device configured for capturing an digital image of a physical object. The computer includes an image acquiring card for receiving the digital image from the charge coupled device. The computer further includes: an image correction program configured for correcting the digital image, the image correction program comprising: a deviation value computing module configured for mapping a regular grid according to the length and the width of a work plane of the measuring machine, and a preconfigured interval of the grid, wherein intersecting points of the regular grid refer to reference points; the deviation values computing module further configured for computing deviation values of the reference points; and a correction module configured for correcting real coordinate values of points in the digital image according to the deviation values of the reference points.

Another preferred embodiment provides a computer-based method for correcting an image. The method includes: mapping a regular grid according to the length and the width of a work plane of a measuring machine, and a preconfigured interval of the grid, wherein intersecting points of the regular grid refer to reference points; computing deviation values of all the reference points; capturing a digital image of a physical object through the measuring machine; correcting the real coordinate value of all points of the digital image according to the deviation values of the reference points.

Other advantages and novel features of the present invention will be drawn from the following detailed description of a preferred embodiment and preferred method with the attached drawings.

### BRIEF DESCRIPTION OF THE DRAWINGS

FIG. 1 is a schematic diagram of an original regular grid;

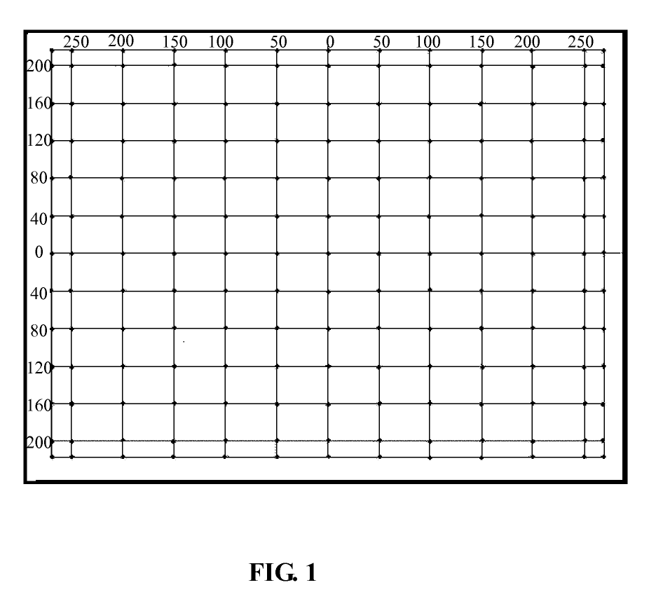

FIG. 2 is a schematic diagram of an image of the regular grid in FIG. 1

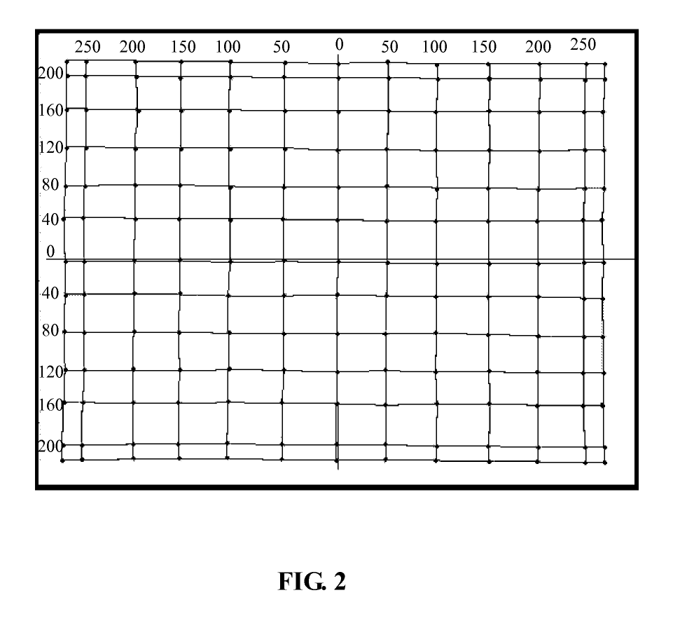

FIG. 3 is a schematic diagram of hardware configuration of a system for correcting an image in accordance with a preferred embodiment;

FIG. 4 is a schematic diagram of function modules of an image correction program in FIG. 3;

FIG. 5 is a flowchart illustrating a method for computing deviation values of reference points;

FIG. 6 is a flowchart illustrating a method for correcting the deviation values of the reference points;

FIG. 7 is a flowchart illustrating a method for correcting an image; and

FIG. 8 is a schematic diagram of computing the four reference points that are nearest to a point in the image.

### DETAILED DESCRIPTION OF THE INVENTION

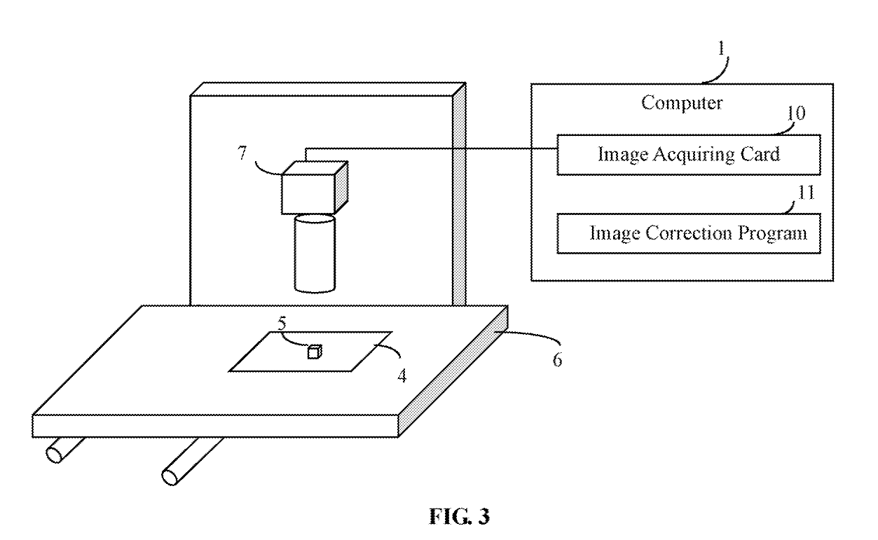

FIG. 3 is a schematic diagram of hardware configuration of a system for correcting an image (hereinafter “the system”), in accordance with a preferred embodiment. The system typically includes a computer 1 and a measuring machine 6. A physical object 5 is placed on a work plane of the measuring machine 6. A CCD 7 is installed on Z-axle of the measuring machine 6, and is used for capturing a digital image of the physical object 5.

Furthermore, for correcting the image captured by the CCD 7, the system may also include a calibration gauge 4 placed under the physical object 5.

The computer 1 typically includes an image acquiring card 10, and an image correction program 11. The CCD 7 connects with the image acquiring card 10 electronically, and transfers the digital image to the computer 1 through the image acquiring card 10. The digital image can be displayed on a monitor (not shown) of the computer 1.

The image correction program 11 is configured for correcting the digital image.

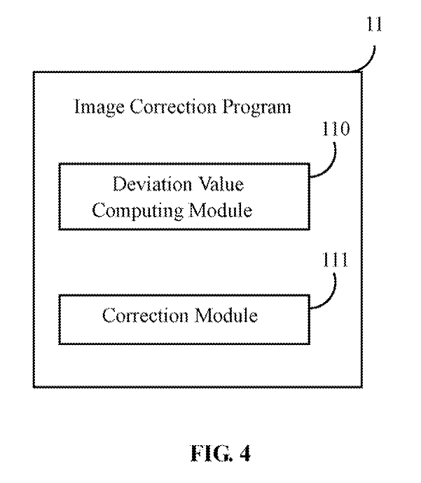

FIG. 4 is a schematic diagram of function modules of the image correction program 11. The image correction program 11 mainly includes a deviation value computing module 110 and a correction module 111.

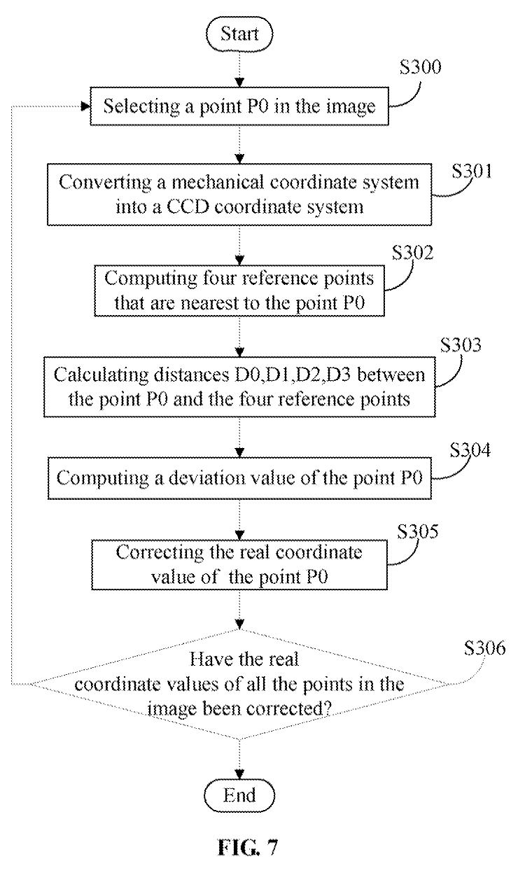

The deviation value computing module 110 is configured for mapping a regular grid according to the length and the width of the work plane of the measuring machine 6, and an interval of the grid that is preconfigured by users. Intersecting points of the regular grid refer to reference points. The deviation values computing module 110 is further configured for computing deviation values of the reference points. The deviation value of each reference point is a difference between an ideal coordinate value of the reference point and a real coordinate value of the reference point. The real coordinate values of the reference points are computed by the computer 1, and the ideal coordinate values of the reference points are measured with the calibration gauge 4. The deviation values of the reference points can be recorded in a table (referring to FIG. 7). The table can be stored in the computer 1.

The correction module 111 is configured for correcting the real coordinate value of points of the digital image according to the deviation values of the reference points. The method for correcting the real coordinate value of a point P0 of the digital image can be described as followed:

(1) The correction module 111 calculates four reference points that are nearest to the point P0. (2) The correction module 111 computes four distances D0, D1, D2, and D3 between the point P0 and the four reference points. (3) The correction module 111 reads four deviation values A0, A1, A2, and A3 of the four reference points from the table mentioned above. (4) Using the formula:

$$A = \frac{\frac{A 0}{D 0} + \frac{A 1}{D 1} + \frac{A 2}{D 2} + \frac{A 3}{D 3}}{\frac{1}{D 0} + \frac{1}{D 1} + \frac{1}{D 2} + \frac{1}{D 3}}$$

the correction module 111 computes a deviation value A of the point P0. (5) The correction module 111 corrects the real coordinate value of the point P0 by mathematically adding the deviation value A for obtaining the ideal coordinate value of the point P0.

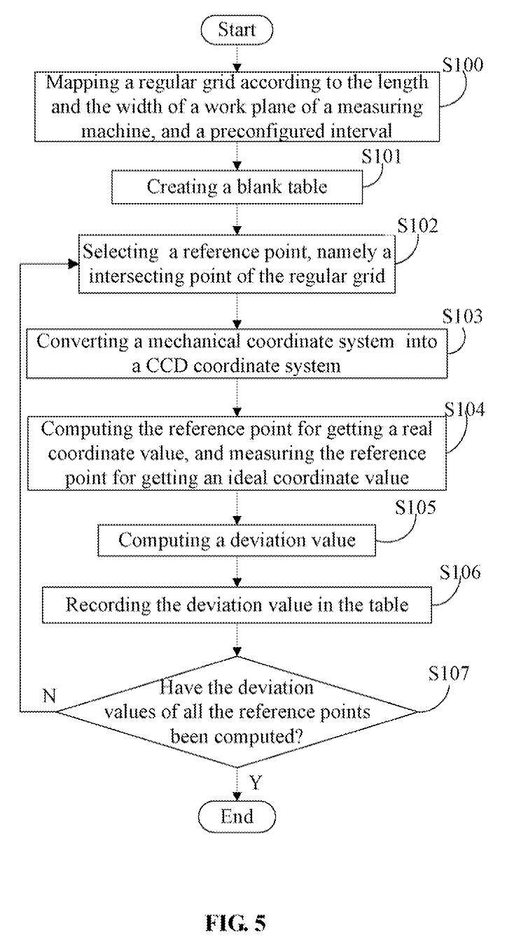

FIG. 5 is a flowchart illustrating a method for computing the deviation values of the reference points. In step S100, the deviation value computing module 110 maps a regular grid according to the length and the width of the work plane of the measuring machine 6, and an interval of the grid that is preconfigured by users. Intersecting points of the regular grid refer to reference points.

In step S101, the deviation value computing module 110 creates a blank table for recording deviation values of the reference points.

In step S102, the deviation value computing module 110 selects one of the reference point, namely selects one of the intersecting point of the regular grid.

In step S103, the deviation value computing module 110 converts a mechanical coordinate system into a CCD coordinate system, if the current coordinate system is the mechanical coordinate system. The mechanical coordinate system takes the center point of the work plane of the measuring machine 6 as an origin, and the CCD coordinate system takes the center point of the CCD 7 as an origin.

In step S104, the computer 1 computes the real coordinate value of the selected reference point under the CCD coordinate system, and the calibration gauge 4 measures an ideal coordinate value of the selected reference point under the CCD coordinate system.

In step S105, the deviation value computing module 110 computes the deviation value of the selected reference point by computing the difference between the real coordinate value and the ideal coordinate value of the selected reference point.

In step S106, the deviation value computing module 110 records the deviation value into the table created above.

In step S107, the deviation value computing module 110 determines whether the deviation values of all the reference points have been computed. If the deviation value of any reference point is not computed, the procedure returns to step S102 described above, and the deviation value computing module 110 selects a next intersecting point of the regular grid. Otherwise, if the deviation values of all the reference points have been computed, the procedure ends.

The table that records the deviation values of all the reference points may be stored in an encrypted document in the computer 1 so as to prevent unauthorized access.

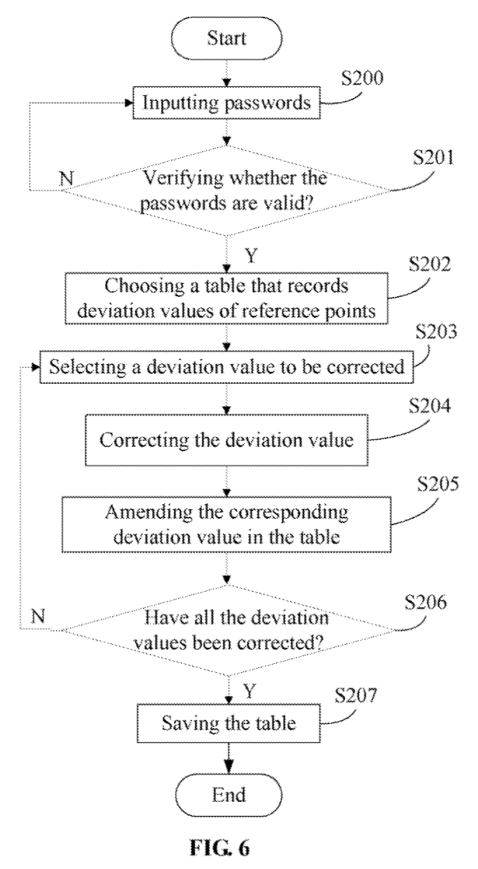

Sometimes, the deviation values of the reference points recorded in the table may be inaccurate due to some factors. Thus, the deviation values need to be corrected sometimes. The procedure for correcting the deviation values of the reference points refers to FIG. 6.

FIG. 6 is a flowchart illustrating a method for correcting the deviation values of the reference points.

In step S200, a user inputs passwords to open the encrypted document. In step S201, the passwords are verified. If the passwords are invalid, the procedure returns to step S200.

If the passwords are valid, in step S202, the table that records the deviation values is selected. In step S203, the deviation value computing module 110 selects a deviation value to be corrected. In step S204, the deviation value computing module 110 corrects the deviation value. The method of correcting the deviation values is achieved by computing the deviation value over again. The method for computing the deviation value of the reference point is described in FIG. 5.

In step S205, the deviation value computing module 110 amends the corresponding deviation value in the table. In step S206, the deviation value computing module 110 determines whether all the deviation values have been corrected. If any deviation value is not corrected, the procedure returns to step S203. Otherwise, in step S207, the table is saved.

FIG. 7 is a flowchart illustrating a method for correcting the image. In step S300, the correction module 111 selects a point P0 of the digital image of the physical object 5.

In step S301, the correction module 111 converts a mechanical coordinate system into a CCD coordinate system, if the current coordinate system is the mechanical coordinate system.

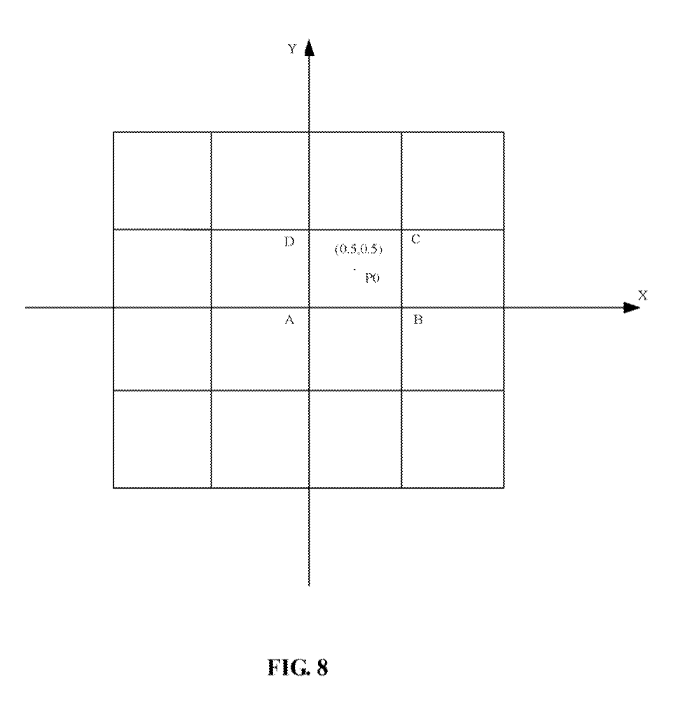

In step S302, the correction module 111 calculates four reference points that are nearest to the point P0. Referring to FIG. 8, FIG. 8 is a schematic diagram of calculating the four reference points. In FIG. 8, the coordinate value of the P0 is (0.5, 0.5), the correction module 111 computes the distances between the point P0 and all the reference points, namely all the intersecting points respectively, and obtains four reference points that are nearest. In FIG. 8, the four reference points are point A, point B, point C, and point D.

In step S303, the correction module 111 reads the four distances D0, D1, D2 and D3 between the point P0 and the four points A, B, C, and D.

In step S304, the correction module 111 computes a deviation value A of the point P0 using the following formula:

$$A = \frac{\frac{A 0}{D 0} + \frac{A 1}{D 1} + \frac{A 2}{D 2} + \frac{A 3}{D 3}}{\frac{1}{D 0} + \frac{1}{D 1} + \frac{1}{D 2} + \frac{1}{D 3}}$$

In the above formula, A0, A1, A2, and A3 are the deviation values of the point A, the point B, the point C, and the point D.

The above formula can be converted as

$$A = \frac{\begin{matrix}A 0 * D 1 * D 2 * D 3 + A 1 * D 0 * D 2 * D 3 + \\ A 2 * D 0 * D 1 * D 3 + A 3 * D 0 * D 1 * D 2\end{matrix}}{\begin{matrix}D 1 * D 2 * D 3 + D 0 * D 2 * \\ D 3 + D 0 * D 1 * D 3 + D 0 * D 1 * D 2\end{matrix}}$$

and marking

$$\{ \begin{matrix}T 0 = D 1 * D 2 * D 3 \\ T 1 = D 0 * D 2 * D 3 \\ T 2 = D 0 * D 1 * D 3 \\ T 3 = D 0 * D 1 * D 2\end{matrix}$$

then

$$A = \frac{A 0 * T 0 + A 1 * T 1 + A 2 * T 2 + A 3 * T 3}{T 0 + T 1 + T 2 + T 3}$$

In step S305, the correction module 111 corrects the real coordinate value of the point P0 by adding the deviation value A with the real coordinate value of the point P0, and thus, obtains the ideal coordinate value of the point P0.

In step S306, the correction module 111 determines whether the real coordinate values of all the points of the digital image have been corrected. If the real coordinate value of any point in the digital image is not corrected, the procedure returns to step S300. Otherwise, if the real coordinate values of all the points in the digital image have been corrected, the procedure ends.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

What is claimed is:

1. A system for correcting an image, the system comprising a computer and a measuring machine, the measuring machine comprising a charge coupled device configured for capturing a digital image of a physical object, the computer comprising an image acquiring card for receiving the digital image from the charge coupled device, and the computer further comprising:
an image correction program configured for correcting the digital image, the image correction program comprising:
a deviation value computing module configured for mapping a regular grid according to the length and the width of a work plane of the measuring machine, and a preconfigured interval of the grid, wherein intersecting points of the regular grid refer to reference points;
the deviation values computing module further configured for computing deviation values of the reference points; and
a correction module configured for correcting real coordinate values of points of the digital image according to the deviation values of the reference points.

2. The system according to claim 1, wherein the deviation value of each reference point is a difference between an ideal coordinate value of the reference point and a real coordinate value of the reference point.

3. The system according to claim 2, wherein the deviation value of each reference point is recorded in a table.

4. The system according to claim 2, wherein the ideal coordinate value of the reference point is measured by a calibration gauge.

5. The system according to claim 2, wherein the real coordinate value of the reference point is computed by the computer.

6. A computer-based method for correcting an image, the method comprising:
mapping a regular grid according to the length and the width of a work plane of a measuring machine, and a preconfigured interval of the grid, wherein intersecting points of the regular grid refer to reference points;
computing deviation values of all the reference points;
capturing a digital image of a physical object through the measuring machine;
correcting the real coordinate value of all points of the digital image according to the deviation values of the reference points.

7. The method according to claim 6, wherein the step of computing deviation values of all the reference points comprises:
selecting one of the reference point;
computing a real coordinate value of the selected reference point by the computer;
measuring an ideal coordinate value of the selected reference point by a calibration gauge;
obtaining a deviation value of the selected reference point by computing a difference between the ideal coordinate value and the real coordinate value; and
repeating the above steps until the deviation values of all the reference points are computed.

8. The method according to claim 6, wherein the step of correcting the real coordinate value of all points of the digital image comprises:
selecting a point P0 of the digital image;
calculating four reference points that are nearest to the point P0;
calculating four distances D0, D1, D2, and D3 between the point P0 and the four reference points respectively;
reading deviation values A0, A1, A2, and A3 of the four reference points from a table stored in the computer;
computing a deviation value of the point P0 according to the four distances D0, D1, D2, D3 and the four deviation values A0, A1, A2, A3;
correcting the real coordinate value of the point P0 according to the deviation value of the point P0; and
repeating the above steps until the real coordinate values of all the points of the image are corrected.
